(19) United States
(12) Patent Application Publication
(10) Pub. No.: US 2006/0055582 A1
(43) Pub. Date: Mar. 16, 2006

(54) Remote control

(76) Inventor: Matthias Wendt, Wurselen (DE)

Correspondence Address: PHILIPS INTELLECTUAL PROPERTY & STANDARDS, P.O. BOX 3001, BRIARCLIFF MANOR, NY, 10510, US

(21) Appl. No.: 10/528,931

(22) PCT Filed: Sep. 17, 2003
(86) PCT No.: PCT/IB03/03998

§ 371 Date: Mar. 23, 2005

(30) Foreign Application Priority Data
Sep. 27, 2002 (DE) 10245354.3

(51) Int. Cl. G08C 19/12

(52) U.S. Cl. 341/175

(57) ABSTRACT

The invention relates to a remote it comprises an operating element (1) which is provided to transmit tactile information via the operating element (1), which information is adjustable by a user (20) and/or controllable by a control unit (4).

The invention relates to a remote control comprising an operating element.

Modern household apparatuses, be it apparatuses for entertainment electronics, kitchen appliances, alarm installations, lamps etc. have a multitude of adjustable parameters and functions, such as the sound volume of the amplifier, the luminance of a lamp, the intensity of microwave heating or the point of time for activating alarm installations. Many apparatuses are controllable by means of a remote control. Due to the large number of remotely controllable apparatuses, an inconvenient number of remote controls is often present in one household. Therefore, there is a great desire for universal remote controls.

The larger the multitude of control facilities, the more complex a universal remote control must be. Remote controls essentially built on individual keys often do not allow that all control facilities of the various apparatuses to be controlled can be realized with the limited number of keys. The control of exotic functions of an apparatus is difficult for a user. To meet this problem, remote controls with touch screens have been developed which can display different sets of touch-sensitive keys. These keys can be specified, for example, by the user. In many remote controls with a touch screen, the appearing keys can also be changed in form by means of a computer program carried out by the user. Uninspiring key depictions are thereby prevented.

Keys and touch screens have the drawback that, in a darker room (for example, when watching a movie), they can only be appropriately detected and operated when they are illuminated.

It is therefore an object of the invention to provide an improved remote control.

The object is solved by a remote control comprising an operating element provided for outputting tactile information, which is adjustable by a user and/or controllable by a control unit.

The advantage of the present invention is the versatility of such an operating element with adjustable and controllable tactile feedback. For different functions, different tactile characteristics can be adjusted by a user (for example, a person or an apparatus to be controlled, which can perform adjustments e.g. via bi-directional communication with the remote control and thus becomes a user). The tactile feedback can also be controlled adaptively and need not comply with any fixed temporal or motion-dependent scheme. A controllable tactile feedback can also be realized without an operating function, for example, for transmitting the information that the batteries are almost discharged. The control unit can be formed as a control circuit or as a static control unit (for example, a mechanical resistance plate which, dependent on an angular position, acts on the tactile properties of the operating element).

An advantage of the embodiment defined in claim 2 is the capability of detecting the relevant operating function which is characterized by the respective sequence, e.g. a temporal or an angle-dependent sequence, of possibly different tactile information. The sequence of tactile information or the different types of tactile information transmitted under certain circumstances define the characteristic of an operating function. When the operating function is, for example, the selection of an apparatus to be controlled, a tactile lock-in for each selection point is useful and is comprehensible for the user, while in the case of a fast-forward function, a slow-down can indicate the track limits, etc.

A further aspect of the invention is the changeability of a predetermined tactile characteristic (see claim 3). In the case of volume control, an increasing resistance may indicate that the range of a pleasant volume has been exceeded. The increase of the resistance may be, for example, linear. The operating comfort is enhanced when the user can change such a characteristic according to his own wishes, for example, into a quadratically increasing resistance curve.

An advantage of the invention defined in claim 4 is the additional presentation of optically observable information, for example, the status information “active” or “not active”, for example, by means of a LED, the status information about the function performed (for example, “volume”) which can be displayed by means of a small display or by means of a luminous LED for a selection of function possibilities, or, for example, the information about the volume setting level which can be made better readable on a display in the remote control or in the operating element than on the display of the apparatus to be controlled, which display is typically situated at some distance.

Advantageously, adjusting parameters about the tactile feedback for different functions will be available in the remote control itself, for example, in the form of a table in a memory means from which the control unit reads these data when it knows which function should be performed (see claim 5).

It is advantageous when, as defined in claim 6, the remote control comprises means for measuring the motion and position of the operating element, which means control the adjustments of the tactile feedback and, when required, exchange data with other apparatuses.

For the control of other apparatuses, it is a significant advantage when, in addition to the normal control commands, the motion and position values of the operating element or values derived therefrom are transmitted via the data interface to the apparatus to be controlled. This is defined in claim 7. The apparatus to be controlled may compare the received values with its own values and react accordingly, for example, in that it transmits data to the remote control, which data then produce a tactile feedback via the control unit. This advantage is offered by the embodiment defined in claim 8. This embodiment provides the possibility of receiving, for example, adjusting data of the tactile feedback directly from the apparatus to be controlled instead of reading them from an internally available table. Furthermore, it provides the possibility of interaction. The apparatus to be controlled transmits information which is received by the data interface and then leads to an active, adaptive adjustment of the tactile feedback. For example, without data feedback from the apparatus to be controlled, the remote control does not know the center value for the balance setting. When this knowledge is transmitted by the apparatus to be controlled, the control unit is capable of adjusting the tactile feedback (for example, lock-in) accordingly.

Advantageous embodiments of the operating element are given when a movable implementation is provided which has appropriate operating elements in known or logical manner on the apparatus to be controlled, such as a knob, a tumbler switch, a button or a slider (see claim 9).

As defined in claim 10, it is also advantageous when the adjustable tactile operating element is accompanied by further operating elements and display elements so that remote controlling of many apparatuses can be implemented in a possibly user-friendly way.

A further advantageous implementation is defined in claim 11. When the remote control comprises a speech recognition unit, the function to be performed by the tactile operating element can be input via a speech command without first having to select the function from a menu. All other known types of speech-controlled actions are of course also possible.

Claim 12 defines an advantageous embodiment in which apparatuses to be controlled are automatically detected by means of, for example, Bluetooth technology or radio connections (for example radio LAN). The detected apparatuses then have, for example, the possibility to automatically transmit setting data for the tactile operating element or, for example, to transmit a touch screen design which is suitable for the apparatus to be controlled.

These and other aspects of the invention are apparent from and will be elucidated with reference to the embodiments described hereinafter.

In the drawing:

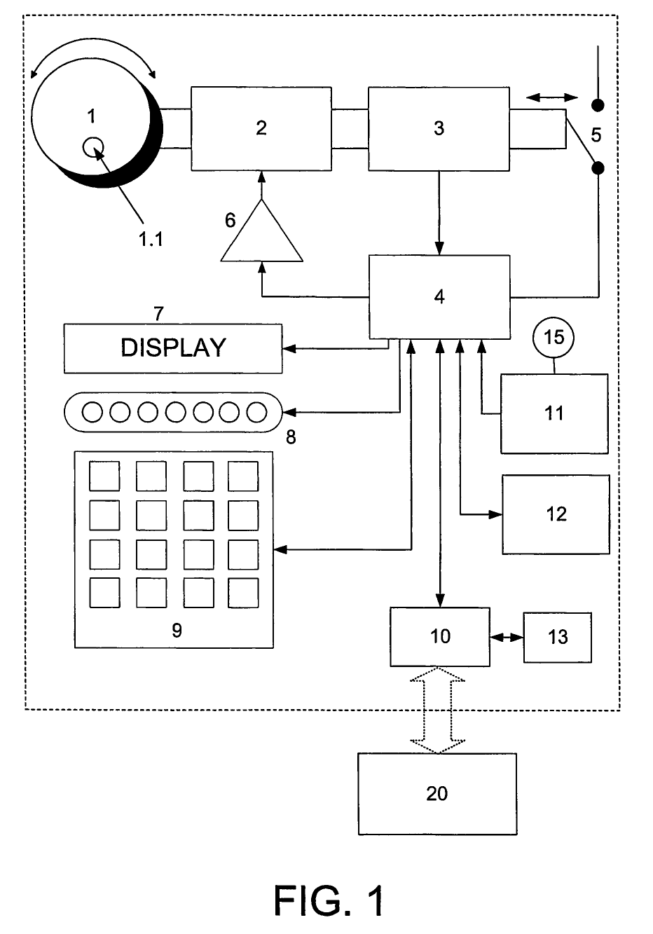

FIG. 1 diagrammatically shows a remote control with a haptic operating element and an apparatus to be controlled (outside the broken line frame around the remote control elements).

FIG. 1 shows diagrammatically a haptic operating element 1 of a remote control in the form of a knob. It may alternatively be a slider, a tumbler switch or a button, or a realization in which several of these possibilities are combined (for example, a knob which can be pressed). A button function is also realized via the switch 5 in FIG. 1. In the case of knobs, sliders and tumblers, a magnetorheologic liquid can be used to flexibly control the tactile information transmitted, upon operation, to the user. A haptic knob, which can be electronically controlled via a magnetorheologic liquid, is known from, for example, European patent application EP 1 168 622 A2. Arbitrary slow-down effects simulating a lock-in or constituting an increasing resistance can thus be generated. Such a knob can be manufactured with a small volume and a light weight. By means of a knob, settings such as volume, balance, lamp dimming, selection of apparatuses, etc can be operated. Each of these operating functions has its own tactile feedback characteristic. For example, in the case of volume control, quality can be simulated by applying a small resistance. At a too high setting of the volume, an increase of the resistance is also possible. Used as selection switches, lock-in points are simulated; dependent on the number, different angular distances between the lock-in points can be realized.

The knob 1 may of course also be provided to transmit tactile information which is not related to the instantaneous operating function, for example, a vibration as a warning for a decreasing battery voltage. To realize a vibration, the operating element 1 is coupled, for example, to a mechanical excitation element, for example, a piezoelement.

Dependent on the position in which the operating element 1, here realized as a knob, is arranged on the remote control, the knob may also comprise a visualization element 1.1. In its simplest case, this is a LED which indicates whether the knob is “active” or “not active” for operation, in that it lights up or does not light up. A plurality of LEDs can indicate which operating function is currently active; this can be achieved in an even more flexible way in that a non-rotating display is advantageously arranged in the knob. The display can then indicate “volume” or “balance” or “selector” or other keywords describing the operating function. When the operating element 1 is not suitable for providing such a visualization element, the visualization element 1.1 may also be accommodated in the remote control, for example, as an independent visualization element or as a part of a larger display.

To control the knob 1 operating in this embodiment with a magnetorheologic liquid, a position encoder 3 is used which detects the (angular) position by means of a sensor which can determine the direction of the magnetic field. The position, direction of rotation and possibly other parameters such as rotational speed or the push-in position of a knob are passed on to the control unit 4. Based on the selected operating function, the control unit reads a preset table from a RAM component 12, which table describes the characteristic of the knob 1 for this operating function. Instead of a RAM memory 12, other known storage media may be used. Based on the table values and the motion and position values, the control unit 4 controls an actuator 2 via a driver 6, which actuator changes the motion resistance of the knob by actuating the magnetorheologic liquid so that tactile information is passed on via the operating element 1.

Typically, other operating and visualizing elements, such as a display 7, a keyboard 9 which may also be realized as a touch screen, or indicators 8 indicating, for example, which apparatus is currently controlled are also components of the operating and information surface of a remote control.

The settings performed by means of the knob 1 are passed on via a data interface 10, for example an infrared transmitter or a radio transmitter to the apparatus 20 to be controlled. When the data interface 10 is implemented in a bi-directional manner (i.e. for transmitting and receiving), it is possible that the remote control can receive corresponding feedback from the apparatus 20 to be controlled, which feedback indicates, inter alia, the current setting status which then appears on the display of the remote control. In this way, the user can easily detect on the remote control which setting he has reached without having to decipher the display of the apparatus 20 which may be typically remote by several meters. In the case of operating functions such as “balance”, it will thus be possible that, dependent on the original setting on the apparatus 20, the control unit 4 knows when the lock-in point for the “neutral” setting must be triggered. This enhances the operating comfort for a very large number of operating functions. Actually, the apparatus 20 to be controlled controls the haptic properties of the operating element 1 in this case (by transmitting data to the data interface 10 and by subsequently passing on the data to the control unit 4). The apparatus to be controlled may also transmit its own table for the settings of the tactile information to the remote control so that corresponding control elements of the apparatus can be simulated. The apparatus 20 to be controlled thus becomes a user of the remote control because it can perform settings similarly as a person can do in this case, for example, by means of a computer program with a connection to the data interface.

In many operating functions such as “tuning”, i.e. when a radio station is searched, the tactile information can be controlled adaptively so that the user is informed when a station has been found. The distances between the tactile information in the case of “tuning” cannot be stored in a table. Only the type of tactile information can be stored and, on the basis of the data transmitted by the apparatus 20 to be controlled (in this case a tuner or receiver), the tactile information is controlled adaptively. The apparatus 20 to be controlled can thus directly act on the tactile information to be transmitted by the operating element 1. Directly passing on control signals transmitted by the apparatus 20 to be controlled to the operating element 1 or the actuator 2 constitutes an embodiment of the invention described hereinbefore. A circumvention of the control unit 4 can be enforced, for example, by certain control signals or signal characteristics transmitted by the apparatus 20 to be controlled.

When a data interface 10 is realized, for example, as a USB port or a RS232 interface, a data exchange via a cable with a computer is also possible, via which the tables for setting the tactile feedback can then be modified. In this way, for example, the characteristic of the increase of the resistance in the case of volume control can be changed from a linear to a quadratic characteristic, dependent on the user's taste.

The data interface can also be realized as a standardized Bluetooth interface or as a wireless LAN interface. Apparatuses equipped in this way are then automatically detected and are available for remote control. Wireless communication systems, apparatuses and methods particularly comprising Bluetooth are known from international patent application WO 01/30031 A1.

A further improvement of the operating comfort is also achieved by a speech recognition unit 11. The user gives a short command, for example, “DVD volume” or “CD track” into a microphone 15 arranged on the remote control and the corresponding function is set via the control unit 4 and can be operated by means of the operating element 1, dependent on the operating function. A speech-controlled remote control is known from international patent application WO 02/17625 A1. By means of a display and a speech recognition unit, more complex interactions can also be performed, for example, changing a characteristic so that no additional computer is required.

The operating element need not be implemented as a controllable operating element with a magnetorheologic liquid or the like. It is alternatively possible to generate a tactile feedback to the user by other means, for example, mechanical means (controllable brake, exchangeable or adjustable resistance plate).

1. A remote control comprising an operating element (1) provided for outputting tactile information which is adjustable by a user (20) and/or controllable by a control unit (4).

2. A remote control as claimed in claim 1, characterized in that the operating element (1) is provided for performing several operating functions, wherein a given characteristic of tactile information is assigned to each operating function.

3. A remote control as claimed in claim 2, characterized in that the characteristic of tactile information is changeable for one of the operating functions.

4. A remote control as claimed in claim 1, characterized in that the remote control and/or the operating element (1) comprises a visualization element (1.1) which is provided for representing optical information about the status of the operating element (1) and/or the function performed with the operating element (1).

5. A remote control as claimed in claim 1, characterized in that the control unit (4) is provided to read parameters for controlling the tactile information of the operating element (1) from a storage means (12).

6. A remote control as claimed in claim 1, characterized in that the remote control comprises
a measuring unit (3) coupled to the control unit (4) for measuring motion and position values of the operating element (1), and
a data interface (10) coupled to the control unit (4) for transmitting and/or receiving data.

7. A remote control as claimed in claim 6, characterized in that the control unit (4) is provided to transmit the motion and/or position values via the data interface (10).

8. A remote control as claimed in claim 6, characterized in that the control unit (4) is provided to receive parameters for controlling the tactile feedback of the operating element (1) via the data interface (10).

9. A remote control as claimed in claim 1, characterized in that the operating element (1) is implemented to rotate and/or slide and/or be pressed and/or tilt.

10. A remote control as claimed in claim 1, characterized in that the remote control comprises a display (7) and/or a touch screen (9) and/or operating keys (9).

11. A remote control as claimed in claim 1, characterized in that the remote control comprises a speech recognition unit (11).

12. A remote control as claimed in claim 1, characterized in that the remote control comprises means (13) for automatically detecting apparatuses to be controlled.
